(19) United States
(12) Patent Application Publication
(10) Pub. No.: US 2019/0136964 A1
(43) Pub. Date: May 9, 2019

(54) TRANSMISSION SHIFTING SYSTEM

(71) Applicant: FORD GLOBAL TECHNOLOGIES, LLC, Dearborn, MI (US)

(72) Inventors: Ramon Marquez TAPIA, Tlalnepantla (MX); Eva Talia HUERTA SANCHEZ, Mexico City (MX)

(21) Appl. No.: 15/805,837

(22) Filed: Nov. 7, 2017

(51) Int. Cl. F16H 59/08; F16H 63/42; F16H 61/28; G06F 3/01; G06K 9/00

(52) U.S. Cl. CPC F16H 59/08; F16H 63/42; F16H 2063/423; G06F 3/017; G06K 9/00355; F16H 61/2807

(57) ABSTRACT

A vehicle includes a transmission, a hologram generator, and a controller. The transmission is configured to shift between a plurality of gears. The hologram generator is configured to project a holographic transmission gear selector. The controller is programmed to, responsive to an operator hand traversing a predetermined path relative to the holographic transmission gear selector, shift the transmission between the plurality of gears.

### TECHNICAL FIELD

The present disclosure relates to vehicles having transmissions configured to shift between a plurality of gears.

### BACKGROUND

Vehicles may include transmissions that are configured to shift between a plurality of gears.

### SUMMARY

A vehicle includes a transmission, a hologram generator, and a controller. The transmission is configured to shift between a plurality of gears. The hologram generator is configured to project a holographic transmission gear selector. The controller is programmed to, responsive to an operator hand traversing a predetermined path relative to the holographic transmission gear selector, shift the transmission between the plurality of gears.

A vehicle includes a transmission, a hologram generator, a camera, and a controller. The transmission has a plurality of gears. The hologram generator is configured to project a holographic transmission gear selector. The camera is configured to detect an operator hand movement along a predetermined path relative to the holographic transmission gear selector. The controller is programmed to, responsive to the operator hand traversing the predetermined path, shift the transmission from a first to a second of the plurality of gears.

A method of shifting a vehicle transmission having a plurality of gears includes projecting a hologram representative of a transmission gear selector, detecting an operator hand movement along a predetermined path relative to the hologram, and shifting the transmission between the plurality of gears responsive to the operator hand movement along the predetermined path.

### BRIEF DESCRIPTION OF THE DRAWINGS

FIG. 1 is a schematic illustration of a representative vehicle;

FIG. 2 is flowchart illustrating a method of shifting a vehicle transmission between a plurality of gears;

FIG. 3 is a perspective view of a center console of the vehicle that includes a hologram generator which is projecting a holographic transmission gear selector; and

FIG. 4 is a perspective view of the center console of the vehicle that includes the hologram generator which is projecting a holographic notification of a particular gear selection.

### DETAILED DESCRIPTION

100101 Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

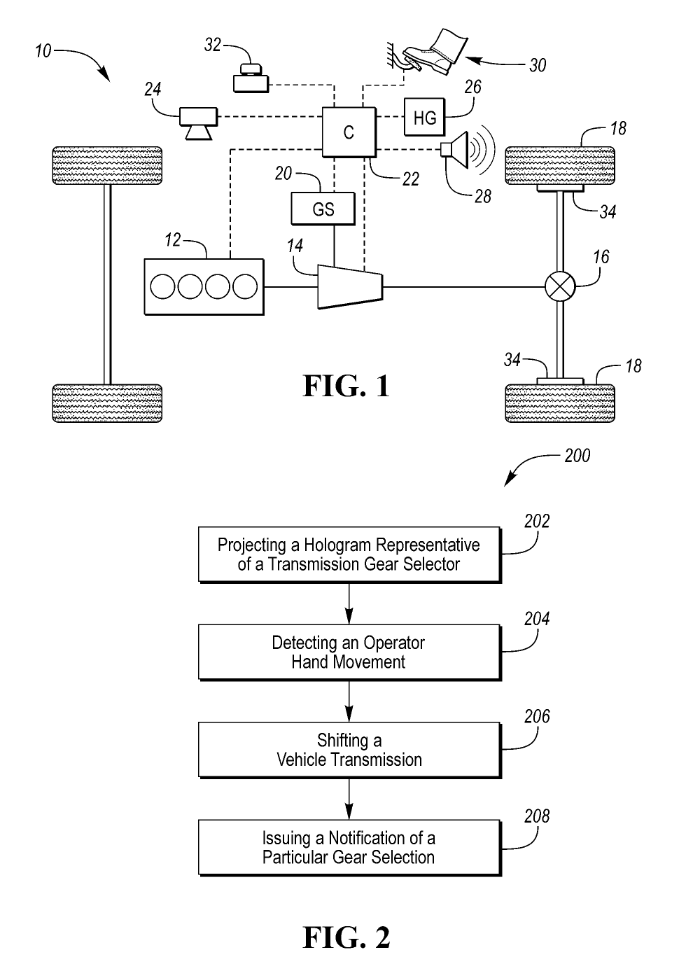

Referring to FIG. 1, a representative vehicle 10 is illustrated. The vehicle 10 includes a powertrain. The powertrain may include a power generator that is configured to generate torque and power within the powertrain, such as an internal combustion engine 12. The vehicle operator may request a desired torque and/or power output of the engine 12 by depressing an accelerator pedal (not shown). The powertrain may further include a gearbox 14, a differential 16, drive wheels 18, and various other components such as gears and/or driveshafts. For example, a torque converter or a launch clutch may be disposed between the engine 12 and the gearbox 14. The gearbox 14 may be a multi-ratio transmission that provides multiple gear ratios between the input and output of the gearbox 14. The gearbox 14 may include a gear selecting mechanism 20 that is configured to shift the gearbox 14 between a plurality of gears which may include, but is not limited to, a parked gear (P), a reverse gear (R), a neutral gear (N), a drive gear (D), a sport mode (S), and a low gear (L). The plurality of gears may collectively be represented as PRNDSL. The gear selecting mechanism 20 may be internal to the gearbox 14 and may include an actuator (i.e., electric motor, solenoid, hydraulic cylinder, etc.) that transitions the gearbox 14 between the plurality of gears PRNDSL. Alternatively, in the event that the gearbox 14 is representative of a manual transmission or an automatic transmission that may be shifted manually, the gear selecting mechanism 20 may be configured to shift the gearbox 14 between a plurality of forward gearing ratios (e.g., 1^{st}, 2^{nd}, 3^{rd}, 4^{th}, 5^{th}, etc.). In this alternative embodiment, the gear selecting mechanism 20 may also include a reverse gear and several neutral gear positions.

A controller 22 may be in communication with and configured to control various subsystems of the vehicle 10 including the engine 12, the gearbox 14 (e.g., to shift the gearbox 14 between numbered gears to change the input/output rotational speed ratio of the gearbox 14), and the gear selecting mechanism 20 of the gearbox 14 (i.e., to shift the gearbox 14 between the parked gear, reverse gear, neutral gear, drive gear, etc.). The controller 22 may also be in communication with other components of the vehicle 10 such as a camera 24, a holographic or hologram generator 26 located within a cabin of the vehicle 10, one or more speakers 28 that may also be located within a cabin of the vehicle 10, a user interface 32 (such as a button) that allows the vehicle operator to lock the gear selecting mechanism 20 in the currently selected gear, and a brake pedal 30 that is configured to engage friction brakes 32 to slow the vehicle 10 or prevent the wheels 18 from turning if the vehicle 10 is already stationary.

While illustrated as one controller, the controller 22 may be part of a larger control system and may be controlled by various other controllers throughout the vehicle 10, such as a vehicle system controller (VSC). It should therefore be understood that the controller 22 and one or more other controllers can collectively be referred to as a “controller” that controls various actuators in response to signals from various sensors to control functions the vehicle 10 or vehicle subsystems. The controller 22 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle 10 or vehicle subsystems.

Control logic or functions performed by the controller 22 may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description.

The control logic may be implemented primarily in software executed by a microprocessor-based vehicle, engine, and/or powertrain controller, such as controller 22. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the vehicle 10 or its subsystems. The computer-readable storage devices or media may include one or more of a number of known physical devices which utilize electric, magnetic, and/or optical storage to keep executable instructions and associated calibration information, operating variables, and the like.

The controller 22 may be configured to receive various states or conditions of the various vehicle components illustrated in FIG. 1 via electrical signals. The electrical signals may be delivered to the controller 22 from the various components via input channels. Additionally, the electrical signals received from the various components may be indicative of a request or a command to change or alter a state of one or more of the respective components of the vehicle 10. The controller 22 includes output channels that are configured to deliver requests or commands (via electrical signals) to the various vehicle components. The controller 22 includes control logic and/or algorithms that are configured to generate the requests or commands delivered through the output channels based on the requests, commands, conditions, or states of the various vehicle components. The input channels and output channels are illustrated as dotted lines in FIG. 1. It should be understood that a single dotted line may be representative of both an input channel and an output channel into or out of a single element. Furthermore, an output channel out of one element may operate as an input channel to another element and vice versa.

Referring to FIG. 2, a method 200 of shifting a vehicle transmission (e.g., gearbox 14) between a plurality of gears (e.g., PRNDSL), or in the event that the transmission is a manual transmission or an automatic transmission that may be shifted manually, between a plurality of gears and gearing ratios (e.g., reverse, neutral 1^{st}, 2^{nd}, 3^{rd th}, 4^{th}, 5^{th}, etc.), is illustrated. The method 200 may be stored as an algorithm and/or control logic within the controller 22. The controller 22 may be programmed to implement the control method 200 based on various conditions of the vehicle 10 or various subsystems of the vehicle 10. The method 200 begins at block 202 by projecting a hologram via the hologram generator 26. The hologram is representative of a gear selector of the gearbox 14 and may be in the shape of a typical gear selector or gear shifting handle.

Once the hologram representative of the gear selector is generated, the method 200 moves on to block 204 where a hand movement of an operator of the vehicle 10 within the vicinity of the hologram is detected. The hand movement may mimic a shifting motion of an actual physical gear selector. The hand movement of the vehicle operator may be detected via the camera 24. The method may remain idle between blocks 202 and 204 until a hand movement of an operator is detected. If the hand movement of the vehicle operator traverses a predetermined path relative to the hologram representative of the gear selector (i.e., a predetermined path in a three-dimensional space within the vicinity of the hologram), the method 200 moves on to block 206 where the gearbox 14 is shifted between the plurality of gears PRNDSL or plurality of gears and gearing ratios (e.g., reverse, neutral 1^{st}, 2^{nd}, 3^{rd}, 4^{th}, 5^{th}, etc.).

The method 200 may additionally require a “virtual holding” of the hologram representative of the gear selector for a predetermined period of time prior to allowing any hand movement of the vehicle operator to shift the gearbox 14 between the plurality of gears PRNDSL or plurality of gears and gearing ratios (e.g., reverse, neutral 1^{st}, 2^{nd}, 3^{rd}, r^{th}, 5^{th}, etc.). For example, the vehicle operator may have to place a hand over the hologram, receive a notification that it is ok to shift gearbox 14, and then move the hand along the predetermined path prior to any shifting occurring within the gearbox 14. The notification that it is ok to shift gearbox 14 after virtually holding the hologram may be a visual notification (e.g., a light on a dashboard or a secondary hologram generated via the hologram generator 26) or an audible notification (e.g., a chime or other sound generated via the one or more speakers 28).

The method 200 may additionally require that the vehicle operator depress the brake pedal 30 prior to shifting the gearbox 14 out the parked gear (P). The gear selecting mechanism 20 of the gearbox 14 may include a lock the prevents the gearbox 14 from shifting out of the parked gear (P). Depressing the brake pedal 30 may release the lock allowing the operator to shift out the parked gear (P). Requiring an application of the brake pedal 30 in order to shift the vehicle 10 out of the parked gear (P) is a safety feature that may prevent undesirable movement of the vehicle 10 that may result when the vehicle is shifted out of the parked gear (P) without an application of the friction brakes 32. Also in order to avoid any undesirable shift out of any of the plurality of gears PRNDSL, the vehicle operator may engage the user interface 32 to lock the gear selecting mechanism 20 in the currently selected gear of the plurality of gears PRNDSL or plurality of gears and gearing ratios (e.g., reverse, neutral 1^{st}, 2^{nd}, 3^{rd}, 4^{th}, 5^{th}, etc.).

The method 200 may also be configured to shift the gearbox 14 between the plurality of gears PRNDSL or plurality of gears and gearing ratios (e.g., reverse, neutral 1^{st}, 2^{nd}, 3^{rd}, 4^{th}, 5^{th}, etc.) based on hand movements of the vehicle operator along multiple predetermined paths. Each individual path may specific to shifting the gearbox 14 from a first particular gear to a second particular gear of the plurality of gears PRNDSL or from a first particular gear to a second particular gear of the plurality of gears and gearing ratios (e.g., reverse, neutral 1^{st}, 2^{nd}, 3^{rd}, 4^{th}, 5^{th}, etc.). For example, the hand movement of the vehicle operator along a first predetermined path may shift the gearbox from one of the plurality of gears PRNDSL to the parked gear (P), the hand movement of the vehicle operator along a second predetermined path may shift the gearbox from one of the plurality of gears PRNDSL to the neutral gear (N), the hand movement of the vehicle operator along a third predetermined path may shift the gearbox from one of the plurality of gears PRNDSL to the reverse gear (R), the hand movement of the vehicle operator along a fourth predetermined path may shift the gearbox from one of the plurality of gears PRNDSL to the drive gear (D).

Once the gearbox 14 has been shifted at block 206, the method 200 moves on to block 208 where a notification is issued indicating which particular gear of the plurality of gears PRNDSL or plurality of gears and gearing ratios (e.g., reverse, neutral 1^{st}, 2^{nd}, 3^{rd}, 4^{th}, 5^{th}, etc.) was selected at block 206. The notification may be a visual notification (e.g., a light on a dashboard or a secondary hologram generated via the hologram generator 26) or an audible notification (e.g., a chime or other sound generated via the one or more speakers 28). If the notification is a secondary hologram generated via the hologram generator 26 a symbol representative of the particular gear selected may be generated. For example, if the parked gear (P) was selected a hologram of a “P” may be generated, if the reverse gear (R) was selected a hologram of an “R” may be generated, if the neutral gear (N) was selected a hologram of an “N” may be generated, if the drive gear (D) was selected a hologram of a “D” may be generated, if the 1^{st} gearing ratio was selected a “1” may be generated, if the 2^{nd} gearing ratio was selected a “2” may be generated, etc. It should be understood that the flowchart in FIG. 2 is for illustrative purposes only and that the method 200 should not be construed as limited to the flowchart in FIG. 2. Some of the steps of the method 200 may be rearranged while others may be omitted entirely.

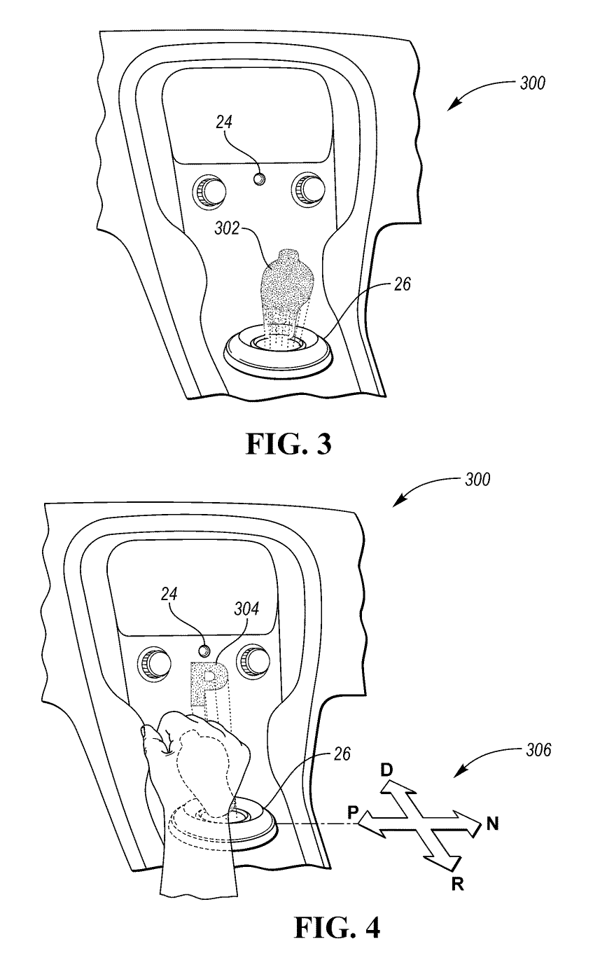

Referring to FIGS. 3 and 4, perspective views of a center console 300 of the vehicle 10 are illustrated. The center console 300 includes the camera 24 and the hologram generator 26. In FIG. 3, the hologram generator 26 is projecting a hologram 302 representative of the gear selector for the gearbox 14. In FIG. 4, the hologram generator 26 is projecting a secondary hologram 304 representative of the particular gear selected. The secondary hologram is in the form of “P” indicating that the parked gear (P) was selected. However, it should be understood that the secondary hologram may be in the form of a symbol of one of the other particular gears of the plurality of gears PRNDSL or plurality of gears and gearing ratios (e.g., reverse, neutral 1^{st}, 2^{nd}, 3^{rd}, 4^{th}, 5^{th}, etc.) depending the specific gear selection.

FIG. 4 also depicts multiple predetermined paths 306, where a specific gear of the plurality of gears PRNDSL will be engaged upon the hand of the vehicle operator traversing one the multiple predetermined path. Alternatively, traversing one of multiple predetermined paths may result in engaging one of the plurality of gears and gearing ratios (e.g., reverse, neutral 1^{st}, 2^{nd}, 3^{rd}, 4^{th}, 5^{th}, etc.). The specific exampled indicates that a forward movement of the hand will engage the drive gear (D), a rearward movement of the hand will engage the reverse gear (R), a leftward movement of the hand will engage the parked gear (P), and a rightward movement of the hand will engage the drive gear (N). It should be understood, however, that the multiple predetermined paths 306 depicted in FIG. 4 are meant for illustrative purposes only and that specific gears of the plurality of gears PRNDSL may be configured to engage based on any desirable predetermined path.

It should be understood that the vehicle configuration described herein is merely exemplary and is not intended to be limited. Other non-hybrid, electric, or hybrid vehicle configurations that include a transmission gearbox that is configured to shift between a plurality of gears should be construed as disclosed herein. Other vehicle configurations may include, but are not limited to, micro-hybrid vehicles, series hybrid vehicles, parallel hybrid vehicles, series-parallel hybrid vehicles, plug-in hybrid electric vehicles (PHEVs), fuel cell hybrid vehicles, battery operated electric vehicles (BEVs), or any other vehicle configuration known to a person of ordinary skill in the art

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A vehicle comprising:
a transmission configured to shift between a plurality of gears;
a hologram generator configured to project a holographic transmission gear selector; and
a controller programmed to, responsive to an operator hand traversing a predetermined path relative to the holographic transmission gear selector, shift the transmission between the plurality of gears.

2. The vehicle of claim 1, wherein the plurality of gears includes a parked gear, a neutral gear, a reverse gear, and a drive gear.

3. The vehicle of claim 2 further comprising a brake pedal, wherein the controller is programmed to, responsive to application of the brake pedal and the operator hand traversing the predetermined path, shift the transmission out of the parked gear.

4. The vehicle of claim 2, wherein the controller is programmed to, responsive to the operator hand traversing the predetermined path, shift the transmission to the neutral gear.

5. The vehicle of claim 2, wherein the controller is programmed to, responsive to the operator hand traversing the predetermined path, shift the transmission to the reverse gear.

6. The vehicle of claim 2, wherein the controller is programmed to, responsive to the operator hand traversing the predetermined path, shift the transmission to the drive gear.

7. The vehicle of claim 1, wherein the controller is further programmed to, responsive to shifting the transmission to a particular gear, issue a notification of the particular gear selection.

8. The vehicle of claim 7, wherein the notification is an audible notification.

9. The vehicle of claim 7, wherein the notification is a holographic notification projected via the hologram generator.

10. A vehicle comprising:
a transmission having a plurality of gears;
a hologram generator configured to project a holographic transmission gear selector;
a camera configured to detect an operator hand movement along a predetermined path relative to the holographic transmission gear selector; and
a controller programmed to, responsive to the operator hand traversing the predetermined path, shift the transmission from a first to a second of the plurality of gears.

11. The vehicle of claim 10, wherein the second of the plurality of gears is a parked gear.

12. The vehicle of claim 10, wherein the second of the plurality of gears is a neutral gear.

13. The vehicle of claim 10, wherein the second of the plurality of gears is a reverse gear.

14. The vehicle of claim 10, wherein the second of the plurality of gears is a drive gear.

15. The vehicle of claim 10, wherein the controller is further programmed to, responsive to shifting the transmission to the second of the plurality of gears, issue a notification of the second gear selection.

16. The vehicle of claim 15, wherein the notification is an audible notification.

17. The vehicle of claim 15, wherein the notification is a holographic notification projected via the hologram generator.

18. The vehicle of claim 10, wherein the transmission includes a plurality of gear ratios and the first of the plurality of gears produces a first forward gear ratio and the second of the plurality of gears produces a second forward gear ratio.

19. A method of shifting a vehicle transmission having a plurality of gears comprising:
projecting a hologram representative of a transmission gear selector;
detecting an operator hand movement along a predetermined path relative to the hologram; and
shifting the transmission between the plurality of gears responsive to the operator hand movement along the predetermined path.

20. The method of claim 18 further comprising:
issuing a notification of a particular gear selection responsive to shifting the transmission to the particular gear.
